(19) United States
(12) Patent Application Publication
(10) Pub. No.: US 2026/0057364 A1
(43) Pub. Date: Feb. 26, 2026

(54) Electronic Payment Verification System and Method

(71) Applicant: Michael HELO, Encino, CA (US)

(72) Inventor: Michael HELO, Encino, CA (US)

(21) Appl. No.: 18/812,263

(22) Filed: Aug. 22, 2024

(51) Int. Cl. G06Q 20/32; G06Q 20/40

(52) U.S. Cl. CPC G06Q 20/3224; G06Q 20/40145

(57) ABSTRACT

The present disclosure provides a payment security system comprising a user device equipped with GPS and Bluetooth capabilities, a location verification module configured to determine a current location of the user device using at least one of GPS and Bluetooth signals, a payment authorization module configured to authorize payments if the current location matches a pre-approved location, and a notification module configured to alert a user of payment attempts from unapproved locations. The system enhances security for electronic payments by verifying the user's location before authorizing transactions, thereby preventing fraudulent activities. The system also includes features for user registration, setup of pre-approved locations, and integration with existing payment methods.

### CROSS-REFERENCE TO RELATED APPLICATIONS

None.

### FIELD OF THE DISCLOSURE

The present disclosure relates to electronic payment security, and more particularly to a mobile application utilizing GPS and/or Bluetooth technology for location verification to prevent fraudulent transactions.

### BACKGROUND OF THE INVENTION

In the modern era, electronic transactions have become a ubiquitous part of daily life. From online shopping to mobile banking, digital payments have revolutionized the way consumers interact with businesses. However, with the convenience of electronic transactions comes the risk of fraudulent activities. Unauthorized transactions, identity theft, and payment fraud are some of the major concerns that plague the digital payment landscape.

In the modern era, electronic transactions have become a ubiquitous part of daily life. From online shopping to mobile banking, digital payments have revolutionized the way consumers interact with businesses. However, with the convenience of electronic transactions comes the risk of fraudulent activities. Unauthorized transactions, identity theft, and payment fraud are some of the major concerns that plague the digital payment landscape.

One of the primary challenges in securing electronic transactions is the verification of the user's identity. Traditional methods of user authentication, such as passwords and PINs, have proven to be vulnerable to various types of attacks. Moreover, these methods do not provide a robust solution for verifying the physical presence of the user at the time of the transaction, which is a common prerequisite for many types of transactions, such as in-store purchases or ATM withdrawals.

Another challenge is the integration of security measures with existing payment systems. Many existing solutions require substantial modifications to the payment infrastructure, which can be costly and time-consuming. Furthermore, these solutions often add complexity to the payment process, which can negatively impact user convenience and overall user experience.

Location-based verification has emerged as a promising approach to address these challenges. By leveraging technologies such as GPS and Bluetooth, it is possible to determine the physical location of the user's device at the time of the transaction. However, existing location-based verification solutions often rely on a single technology, which can lead to inaccuracies in location determination, especially in indoor environments where GPS signals may be weak or unavailable.

Therefore, there is a clear demand for a robust, accurate, and user-friendly solution for securing electronic transactions. Such a solution would ideally integrate seamlessly with existing payment systems, provide reliable location-based user verification, and maintain a high level of user convenience.

### BRIEF SUMMARY OF THE PRESENT INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a payment security system is provided. The system includes a user device equipped with GPS and Bluetooth capabilities. The user device features a user interface for setting up pre-approved locations and linking payment methods. The system also includes a location verification module for determining the current location of the user device using GPS and/or Bluetooth signals. A payment authorization module is included for authorizing payments if the current location matches a pre-approved location. The system further includes a notification module for alerting the user of payment attempts from unapproved locations.

According to other aspects of the present disclosure, the user device may be a mobile device selected from the group consisting of a smartphone, a tablet, and a smartwatch. The location verification module may further comprise a Wi-Fi triangulation system for determining the current location of the user device. The payment authorization module may further comprise a secondary authentication method for authorizing payments from a new location, the secondary authentication method selected from the group consisting of biometric verification and a personal identification number (PIN). The notification module may send alerts to the user via at least one method selected from the group consisting of in-app notifications, SMS, email, and automated phone calls. The user interface may further comprise a dark mode for users who prefer a darker color scheme.

According to another aspect of the present disclosure, a method for securing electronic payments is provided. The method includes receiving user registration and setup information, including pre-approved locations and linked payment methods. The method involves determining the current location of a user device using GPS and Bluetooth signals, and comparing the current location with the pre-approved locations. The method authorizes a payment if the current location matches a pre-approved location and sends a notification to the user if a payment attempt from an unapproved location is detected.

According to other aspects of the present disclosure, the user registration and setup information may further include a secondary authentication method for authorizing payments from a new location, the secondary authentication method selected from the group consisting of biometric verification and a personal identification number (PIN). The user device may be a mobile device selected from the group consisting of a smartphone, a tablet, and a smartwatch. Determining the current location of the user device may further comprise using a Wi-Fi triangulation system. The notification to the user may be sent via at least one method selected from the group consisting of in-app notifications, SMS, email, and automated phone calls. The biometric verification may include at least one of fingerprint recognition and facial recognition. The method may further comprise periodically prompting the user to re-verify their pre-approved locations.

According to yet another aspect of the present disclosure, a non-transitory computer-readable medium storing instructions is provided. When executed by a processor, these instructions cause a device to receive user registration and setup information, including pre-approved locations and linked payment methods. The instructions cause the device to determine the current location using GPS and Bluetooth signals, compare the current location with the pre-approved locations, authorize a payment if the current location matches a pre-approved location, and send a notification to the user if a payment attempt from an unapproved location is detected.

According to other aspects of the present disclosure, the instructions may further cause the device to encrypt all location and transaction data to protect user privacy. The instructions may further cause the device to support biometric authentication for app access and override authorization. The biometric authentication may include at least one of fingerprint recognition and facial recognition. The instructions may further cause the device to periodically prompt the user to re-verify their pre-approved locations. The instructions may further cause the device to integrate with major payment gateways and mobile wallet providers using APIs and SDKs. The instructions may further cause the device to deploy Bluetooth beacons for accurate indoor location verification.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 is an environment of a system for enhancing security of electronic payments, in accordance with one embodiment of the present invention.

FIG. 2 is a block diagram of the system, in accordance with one embodiment of the present invention.

FIG. 3 is a block diagram of a user device, in accordance with one embodiment of the present invention.

FIG. 4 is a method of registering a user, in accordance with one embodiment of the present invention.

FIG. 5 is a method of securing electronic payments, in accordance with one embodiment of the present invention.

FIG. 6 is a flowchart illustrating a secure payment process using a CashBox concept with options for locked and unlocked transfers, in accordance with one embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top.” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a mobile application, referred to as the Payment Security Application (PSA), designed to enhance the security of electronic payments. The PSA achieves this by leveraging GPS and Bluetooth technology to verify the user's location before authorizing any transaction. This ensures that payments can be made from pre-approved locations, providing an additional layer of security against fraudulent transactions. The PSA is designed to integrate seamlessly with existing payment gateways and mobile wallets, providing a secure and convenient payment experience for users. The PSA also includes features for real-time location matching, user notifications, and a user-friendly interface for managing settings and viewing transaction history. In some embodiments, the PSA may use other technologies such as Wi-Fi triangulation, cellular network triangulation, or Near Field Communication (NFC) for location verification. The PSA may also use other authentication methods such as one-time passwords (OTP) sent via SMS or email, security questions, or hardware tokens for user override in case of legitimate transactions from a new location. The PSA may also offer different user interface designs or layouts to cater to different user preferences or accessibility requirements. Furthermore, the PSA may integrate with other types of systems or platforms, such as e-commerce platforms, banking apps, or financial management apps. The PSA may also use other methods to notify users of payment attempts from unapproved locations, such as SMS, email, or automated phone calls.

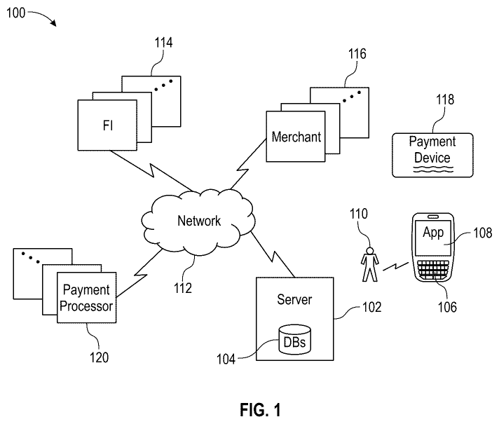

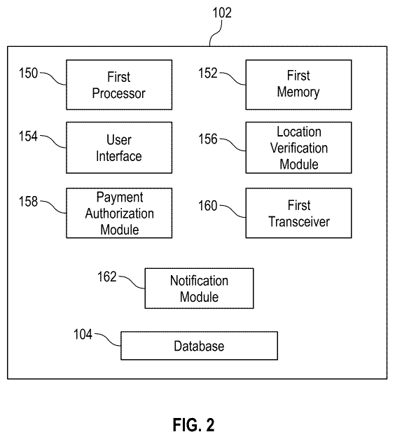

Referring to FIG. 1, an environment 100 in which a system/server 102 encompassing a Payment Security Application (PSA) implements to enhance the security of electronic payments is shown, in accordance with one embodiment of the present invention. The server 102 includes a database (DB) 104 storing the information processed by the server 102. In the present description, the server 102 utilizes the PSA to enhance the security of electronic payments. As such, the PSA 102 is interchangeably used with server 102 hereinafter. FIG. 2 shows a block diagram of PSA/server 102, in accordance with one embodiment of the present invention. The PSA 102 includes a first processor 150, (e.g., a central processing unit (CPU), a graphics processing unit (GPU), or both). The first processor 150 electrically couples to a first memory 152. The first memory 152 includes a volatile memory 152 and/or a non-volatile memory 152. Preferably, the first memory 152 stores instructions or software programs that interact with the other devices in the PSA/server 102 as described below. In one implementation, the first processor 150 executes the instructions stored in the first memory 152 in any suitable manner. In one implementation, the first memory 152 stores digital data indicative of documents, files, programs, web pages, etc. retrieved from the user device 106.

The PSA/server 102 includes a user interface 154. Further, the PSA 102 includes a location verification module 156. The location verification module 156 is configured to check the location of the user device 106 with that of pre-stored locations or pre-approved location data of the user device 106. Further, the PSA 102 includes a payment verification module 158. The payment verification module 158 is configured to verify the payment information from a financial institution (FI) 114 and/or a payment processor 120 when the user device 106 is used to make the payment. Further, the PSA 102 includes a first transceiver 160. The first transceiver 160 sends and receives information from other devices e.g., the user device 106, and/or the FI 114, the payment processor 120, and a merchant 116. Further, the PSA 102 includes a notification module 162. The notification module 162 is configured to generate and transmit notifications from the PSA 102 to other devices e.g., the user device 106.

The PSA 102 communicatively connects to a user device 106 via a network 112. The network 112 includes a wireless network, a wired network or a combination thereof. The network 112 can be implemented as one of the different types of networks, such as intranet, local area network (LAN), wide area network (WAN), the internet, and the like. The network 112 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 112 includes a variety of network devices, including routers, bridges, servers, computing devices, storage devices, and the like.

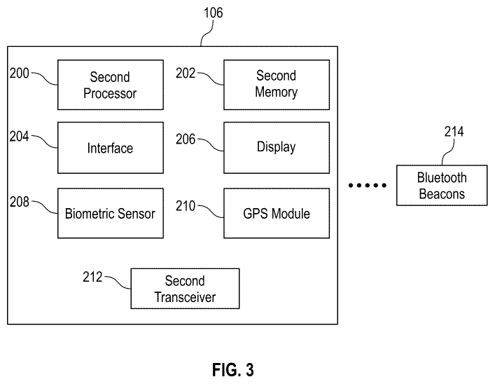

The user device 106 includes, but not limited to, a smart phone, laptop, a desktop computer, a tablet, a smart watch, etc. FIG. 3 shows a block diagram of the user device 106, in accordance with one embodiment of the present invention. The user device 106 includes a second processor 200 (e.g., a central processing unit (CPU), a graphics processing unit (GPU) or both). The second processor 200 electrically couples to a second memory 202. The second memory 202 includes a volatile memory and/or a non-volatile memory. Preferably, the second memory 202 stores instructions or software programs (not shown) that interact with the other devices in the PSA 102. In one implementation, the second processor 200 executes the instructions stored in the second memory 202 in any suitable manner. In one implementation, the second memory 202 stores digital data indicative of documents, files, programs, web pages, etc.

The user device 106 includes an interface 204 allowing a user 110 to operate the user device 106 108. In some implementations, the interface 204 includes a keyboard and/or a touchscreen for operating the user device 106. Further, the user device 106 includes a display 206 (e.g., a liquid crystal display (LCD) or a light-emitting diode (LED)) 206 display. The user device 106 includes a biometric reader 208 such as a fingerprint reader. In some implementations, the biometric reader 208 indicates a fingerprint scanner or fingerprint sensor capable of capturing an image of a person's fingerprint or recognizing the pattern of the fingerprint and then utilizing a database for authenticating the user 110. The biometric reader 208 is positioned at the appropriate place at the user device 106 allowing the user 110 to place/tap his/her finger for scanning the fingerprint.

Further, the user device 106 includes a location sensor or Global Positioning System (GPS) module 210. The GPS module 210 is configured to determine the location of the user device 106. Further, the user device 106 includes a second transceiver 212. The second transceiver 212 sends and receives information from other devices e.g., the PSA 102. In one example, the user device 106 is capable of communicating with external devices using one or more wireless interfaces/protocols such as, for example, 802.11 (Wi-Fi). 802.15 (including Bluetooth™). 802.15 (Wi-Max), 802.22, Cellular standards such as CDMA, CDMA2000, WCDMA, Radio Frequency (e.g., RFID), Infrared, Near Field Magnetics, Near-field communication (NFC), etc.

In one exemplary implementation, the user device 106 is configured to be recognised by bluetooth beacons 214. The beacons 214 might be placed at a merchant 116 location or a store where the user 110 of the user device 106 wishes to make a payment. In one example, the user device 106 includes an application 108 installed that allows access to the information in the PSA 102.

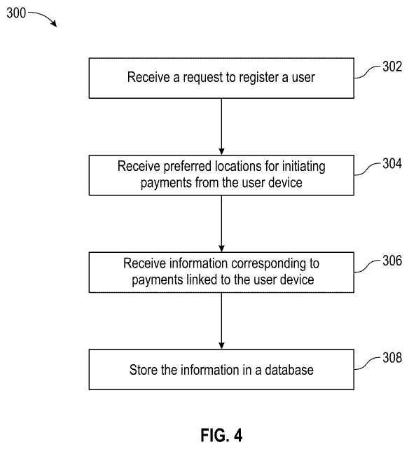

The presently disclosed invention allows the user device 106 to make payment based on pre-approved locations and linked payment methods. In order to make payments at pre-approved locations and linked payment methods, at first, the user and the user device are registered with the PSA 102. Referring to FIG. 4, a method 300 of registering the user and user device is explained. The method 300 starts at step 302. At step 302, the PSA 102 receives a request from a user device 106 to register the user 110. Here, the user provides his/her name, age, profession, address, account details, signatures, etc. At step 304, the PSA 102 receives information corresponding to preferred locations for initiating payments by the user device 106. Here, the user device 106 defines the list of merchants 116 at a variety of locations where he intends to use the user device 106 to make the payments. Here, the merchants 116 indicate approved providers of goods and/or services. In an embodiment, the service enlists merchants to accept payment using a payment device 118, and provides a list of such merchants to the PSA 102. Here, the PSA 102 allows the user 110 to use the service to make purchases with the payment device 118 and to see information regarding the user account with the FI 114 and/or the PSA 102. Further, the PSA 102 receives information corresponding to the preferred mode of payment that he/she intends to link to process the payment, as shown at step 306. Here, the user 110 may define the FI 114 and/or the payment processor 120 to be used for processing his/her payments. At step 308, the PSA 102 stores the information provided by the user 110. For example, the PSA 102 stores the list of pre-approved locations and/or merchants where the user 110 to make payments. In one example, the PSA 102 stores the information such as pre-approved locations where the user 110 frequently makes payments and the payment methods linked to the user's account. The pre-approved locations may be stored as GPS coordinates and Bluetooth beacon identifiers, providing a comprehensive dataset for location verification.

A person skilled in the art understands that the process for receiving user registration and setup information involves the user 110 creating an account on the PSA 102, providing personal information such as their email or phone number, and setting up a secure password. The user 110 may also be prompted to set up pre-approved locations and link their preferred payment methods during the registration process. In some cases, the process of setting up pre-approved locations may involve the user 110 specifying the locations where they regularly make payments. These locations may include their home, office, favorite stores, or any other locations where they frequently conduct transactions. The user 110 may add a new location by entering its address or by using the current location of the user device 106. The location data may be saved as GPS coordinates, and in some cases, the PSA 102 may also use Bluetooth beacons to enhance the accuracy of location verification, especially in indoor environments.

In other cases, the process of linking payment methods may involve the user linking their preferred payment methods to the PSA 102. These payment methods may include credit cards, bank accounts, or mobile wallets. The user 110 may add a new payment method by entering its details, such as the card number and expiry date for a credit card, or the account number and routing number for a bank account. In some cases, the PSA 102 may also support the linking of mobile wallets, allowing users to authorize payments directly from their mobile wallet accounts.

After registering the user 110 and/or the user device 106, whenever the user 110 wishes to make payment at the payment device 118, the PSA 102 verifies the location of the user device 106 to initiate and process the payment. In some aspects, the PSA 102 utilizes the location verification module 156 to determine the current location of the user device 106. The location verification module 156 may use GPS signals from the GPS module 210 to ascertain the geographical coordinates of the user device 106. Simultaneously, the location verification module 156 may scan for Bluetooth beacons 214 in the vicinity. These beacons 214, which can be deployed in specific locations such as stores or offices, emit Bluetooth signals that can be detected by the user device 106. By identifying the signals from the beacons 214, the PSA 102 determines whether the user device 106 is within a specific indoor location.

In some cases, the location verification module 156 may also incorporate a Wi-Fi triangulation system (not shown) to enhance the accuracy of location determination. The Wi-Fi triangulation system can determine the position of the user device 106 based on the strength and origin of Wi-Fi signals in the vicinity. This can be particularly useful in indoor environments where GPS signals may be weak or unavailable.

Once the current location of the user device 106 is determined, the PSA 102 compares this location with the pre-approved locations stored in the user's profile. This comparison is performed by the payment authorization module 158. Here, the payment authorization module 158 authorizes the payment if the current location matches a pre-approved location. If the current location does not match a pre-approved location, the payment is not authorized, and the user 106 is alerted of the attempted transaction.

In some embodiments, the payment authorization module 158 may employ a secondary authentication method to authorize payments from a new location. The secondary authentication method could be biometric verification, such as fingerprint or facial recognition, or a personal identification number (PIN). In some cases, the secondary authentication method may include other forms of verification, such as one-time passwords (OTP) sent via SMS or email, security questions, or hardware tokens. The secondary authentication method acts as an additional layer of security to ensure that even if the user device 106 is used to make a payment from a new location, the payment can be authorized by verifying the user's identity. The alternative (secondary authentication) methods can provide additional security and flexibility for users, allowing them to authorize payments from new locations in a secure and convenient manner.

In some embodiments, the PSA 102 may utilize biometric verification methods as a secondary authentication method for authorizing payments from a new location. Biometric verification methods can provide a high level of security, as they rely on the user's physical or behavioral characteristics, which are difficult to replicate or steal. In some cases, the biometric verification may include fingerprint recognition. The user device may include a fingerprint sensor, which can capture an image of the user's fingerprint and compare it with the fingerprint data stored in the user's profile. If the captured fingerprint matches the stored fingerprint, the user may be granted access to the app or allowed to override the location restriction for a payment.

In other cases, the biometric verification may include facial recognition. The user device 106 may include a camera, which can capture an image of the user's face and compare it with the facial data stored in the user's profile. Facial recognition can analyze various features of the user's face, such as the distance between the eyes, the width of the nose, and the shape of the cheekbones. If the captured facial features match the stored facial features, the user 110 may be granted access to the app or allowed to override the location restriction for a payment.

In yet other cases, the biometric verification may include other forms of biometric data, such as voice recognition, iris recognition, or even behavioral biometrics such as typing rhythm or gait analysis. These alternative methods can provide additional security and flexibility for users, allowing them to choose the biometric authentication method that is the easiest and the safest for them to use. For example, a user 110 who does not have a fingerprint-enabled device may choose to use facial recognition or voice recognition for biometric authentication. Conversely, a user 110 who prefers the convenience and security of fingerprint recognition may choose to use this method for biometric authentication.

In some aspects, the PSA 102 may periodically prompt the user to re-verify their pre-approved locations. This can ensure that the pre-approved locations are up-to-date and accurate, reducing the risk of unauthorized transactions from outdated or irrelevant locations. The re-verification process may involve the user 110 confirming their current locations, adding new locations, or removing outdated locations. The PSA 102 may initiate this re-verification process at predetermined intervals not exceeding ninety days, ensuring a regular update of the pre-approved locations.

In some cases, the re-verification process may involve the user 110 physically visiting each pre-approved location and performing a location verification check. This check may involve using a combination of GPS, Bluetooth signals, and Wi-Fi triangulation to confirm the user device's presence within a predefined proximity threshold of the pre-approved location. Upon successful verification of the user device's presence at the pre-approved location, the user's profile may be updated to reflect the re-verified status of the location.

In other cases, the re-verification process may involve the user interface prompting the user to provide a secondary authentication method, such as biometric verification or a personal identification number (PIN), to authorize the update of the pre-approved location status. This can provide an additional layer of security, ensuring that the re-verification process is authorized by the user.

In yet other cases, the re-verification process may be conditioned upon the absence of any changes to the physical structure or ownership of the pre-approved location that could affect the integrity of the location data. This can be determined by a comparison of the current structural and ownership data against previously stored data for the pre-approved location, ensuring that the location data remains accurate and reliable.

If a payment attempt is detected from an unapproved location, the PSA 102 sends a notification to the user. In one example, the PSA 102 employs the notification module 162 to generate a notification to be sent to the user device 106 in order to alert the user 110 of the attempted transaction. The notification may be sent via various methods, including in-app notifications, short message service (SMS), email, and automated phone calls, depending on the user's preferences and the urgency of the situation.

In some aspects, the PSA 102 may periodically prompt the user to re-verify their pre-approved locations. This can ensure that the pre-approved locations are up-to-date and accurate, reducing the risk of unauthorized transactions from outdated or irrelevant locations. The re-verification process may involve the user confirming their current locations, adding new locations, or removing outdated locations.

In some embodiments, the PSA 102 may be designed to integrate with major payment gateways and mobile wallet providers. This integration can provide a seamless and secure payment experience, allowing the PSA 102 to authorize payments without disrupting the user's payment flow. The integration may be facilitated using APIs and SDKs provided by the payment gateways and mobile wallet providers.

In some cases, the PSA 102 may deploy the Bluetooth beacons 214 for accurate indoor location verification. These beacons can be strategically placed in specific indoor locations, such as stores or offices, to enhance the accuracy of location verification. The PSA 102 can determine whether the user device is within a specific indoor location by identifying the signals from the beacons 214. In one example, each beacon 214 has a uniquely identifiable signal, for accurate indoor location verification within a defined indoor space. Here, the defined indoor space is characterized by a plurality of distinct zones, each zone associated with at least one of the plurality of Bluetooth beacons. The user device is configured to determine its specific location within the defined indoor space by triangulating the signal strengths received from at least three of the uniquely identifiable Bluetooth beacons. The triangulation is further refined by a comparison of the received signal characteristics against a pre-stored map of beacon locations and signal profiles corresponding to the defined indoor space. In some examples, the map is updated periodically to account for any changes in beacon placement or signal characteristics due to environmental factors. The user device, upon determining a match between the triangulated specific location and a pre-approved location within the defined indoor space, is further configured to initiate a secure communication protocol to transmit an authorization signal to a payment processing network, the authorization signal being encrypted using a dynamic encryption scheme that varies with each transaction. The user device is further configured to activate an anti-spoofing protocol to verify the integrity of the Bluetooth beacon signals by ensuring that the time of flight of the signals corresponds to the expected distances between the user device and the plurality of Bluetooth beacons based on the pre-stored map.

In some aspects, the PSA 102 may support a dark mode for users who prefer a darker color scheme. The dark mode can provide a visually appealing and eye-friendly alternative to the standard light mode, especially in low-light environments or for the users 110 who are sensitive to bright light. The user 110 may switch between the light mode and the dark mode according to their preferences, providing a customizable and user-friendly experience.

Further, the PSA 102 employs the notification module 162 to send alerts to the user 110 when a payment attempt from an unapproved location is detected. This process may involve the notification module 162 receiving information about the payment attempt and its associated location from the payment authorization module 158. If the associated location does not match any of the pre-approved locations stored in the user's profile, the notification module 162 may generate an alert to notify the user 110 of the attempted transaction.

In some aspects, the notification module 162 may send the alert to the user 110 via in-app notifications on the user device 106. These notifications may appear on the display 206 of the user device 106, providing immediate and conspicuous alerts about payment attempts from unapproved locations. In-app notifications can be particularly effective in alerting the user in real-time, allowing them to take immediate action if a fraudulent transaction is suspected.

In other aspects, the notification module 162 may send alerts to the user 110 via other methods, such as SMS, email, or even automated phone calls. These alternative notification methods can provide additional ways to alert the user, especially in situations where they may not have immediate access to the app. For example, an SMS alert can reach the user even when the user device 106 is locked or when the app 108 is not running in the foreground. Similarly, an email alert can provide a more detailed record of the alert, including information about the attempted transaction and the unapproved location. Automated phone calls can deliver a pre-recorded message to the user, informing them of the payment attempt from an unapproved location and providing instructions on how to respond.

In yet other aspects, the notification module 162 may use a combination of these methods to send alerts to the user. For instance, the notification module 162 may send an in-app notification and an SMS alert simultaneously, ensuring that the user 106 receives the alert in multiple ways. Alternatively, the notification module 162 may use different methods depending on the user's preferences or the urgency of the alert. For example, the notification module 162 may use in-app notifications for regular alerts and automated phone calls for high-urgency alerts. In these ways, the notification module 162 can provide flexible and effective alerts to the user, enhancing the security of electronic payments.

In some embodiments, the notification module 162 may send alerts to the user via various methods, including in-app notifications, SMS, email, and automated phone calls. These methods can provide different ways to alert the user, depending on their preferences and the urgency of the situation. For instance, in-app notifications can provide immediate alerts on the user device's screen, while SMS and email alerts can reach the user even when the device is locked or when the app is not running in the foreground. Automated phone calls can deliver a pre-recorded message to the user, informing them of the payment attempt from an unapproved location and providing instructions on how to respond. In some cases, the notification module 162 may use a combination of these methods to send alerts to the user, ensuring that the user receives the alert in multiple ways.

The PSA 102 may be embodied in a non-transitory computer-readable medium storing instructions that, when executed by a processor, cause a device to perform a method for securing electronic payments. This method involves receiving user registration and setup information, determining the current location of the device, comparing this location with pre-approved locations, authorizing payments based on location matches, and sending notifications for payment attempts from unapproved locations.

In some aspects, the non-transitory computer-readable medium may store instructions that cause the PSA 102 to receive user registration and setup information. This information may include pre-approved locations where the user frequently makes payments and the payment methods linked to the user's account. The pre-approved locations may be stored as GPS coordinates and Bluetooth beacon identifiers, providing a comprehensive dataset for location verification. The user 110 may add, edit, or remove these locations as per their requirements. Additionally, the user may link their preferred payment methods to the PSA 102, such as credit cards, bank accounts, or mobile wallets.

In some cases, the non-transitory computer-readable medium may store instructions that cause the PSA 102 to determine the current location using GPS and Bluetooth signals. The PSA 102 may use the user device's 106 built-in GPS module to receive signals from satellites and ascertain its geographical coordinates. Simultaneously, the user device 106 may use its built-in Bluetooth module to scan for nearby Bluetooth beacons 214 and identify their signals. By combining the data from GPS and Bluetooth, the device can determine its current location with a high level of accuracy.

In other cases, the non-transitory computer-readable medium may store instructions that cause the PSA 102 to compare the current location with the pre-approved locations. The PSA 102 may use a location comparison algorithm to check whether the current location data matches the GPS coordinates or Bluetooth beacon identifiers of any of the pre-approved locations. If the current location matches a pre-approved location, the device may proceed to the next step of the method.

In some embodiments, the non-transitory computer-readable medium may store instructions that cause the PSA 102 to authorize a payment if the current location matches a pre-approved location. The PSA 102 may use a payment authorization module 158 to authorize the payment, ensuring that payments are made in a secure manner. If the current location does not match a pre-approved location, the payment is not authorized, and the PSA 102 proceeds to the next step of the method.

In other embodiments, the non-transitory computer-readable medium may store instructions that cause the PSA 102 to send a notification to the user if a payment attempt from an unapproved location is detected. The PSA 102 may use a notification module 162 to generate and send the notification, alerting the user of the attempted transaction. The notification may be sent via various methods, including in-app notifications, SMS, email, and automated phone calls, depending on user preferences and the urgency of the situation.

In yet other embodiments, the non-transitory computer-readable medium may store instructions that cause the PSA 102 to encrypt all location and transaction data to protect user privacy. The PSA 102 may use an encryption module to encrypt the data, ensuring that it is secure and unreadable to unauthorized parties. The encryption module may use various encryption algorithms, such as symmetric encryption, asymmetric encryption, or a combination of both, to provide a high level of data security.

In some aspects, the non-transitory computer-readable medium may store instructions that cause the PSA 102 to support biometric authentication for app access and override authorization. The PSA 102 may use a biometric authentication module to verify the user's identity using physical or behavioral characteristics, such as fingerprint or facial recognition. This can provide an additional layer of security, ensuring that the user is the legitimate owner of the device and the account.

In other aspects, the non-transitory computer-readable medium may store instructions that cause the PSA 102 to periodically prompt the user to re-verify their pre-approved locations. The PSA 102 may use a re-verification module to initiate the re-verification process, ensuring that the pre-approved locations are up-to-date and accurate. The re-verification process may involve the user confirming their current locations, adding new locations, or removing outdated locations.

In yet other aspects, the non-transitory computer-readable medium may store instructions that cause the PSA 102 to integrate with major payment gateways and mobile wallet providers using APIs and SDKs. The PSA 102 may use an integration module to facilitate this integration, ensuring that the additional security layer provided by the PSA does not disrupt the user's payment experience.

In some embodiments, the non-transitory computer-readable medium may store instructions that cause the PSA 102 to deploy Bluetooth beacons 214 for accurate indoor location verification. The PSA 102 may use a beacon deployment module (not shown) to deploy the beacons in specific indoor locations, enhancing the accuracy of location verification. The beacon deployment module may support various Bluetooth beacon standards, such as iBeacon, Eddystone, or AltBeacon, ensuring compatibility with a wide range of Bluetooth beacons available in the market.

In some aspects, the user device 106 may be a mobile device equipped with GPS and Bluetooth capabilities. The GPS module 210 in the user device 106 may receive signals from satellites to ascertain the geographical coordinates of the user device 106, providing a broad indication of the device's location. The Bluetooth module in the user device 106 may scan for Bluetooth beacons 214 in the vicinity, providing additional location data that can enhance the accuracy of location verification, especially in indoor environments where GPS signals may be weak or unreliable. The user device 106 may be any type of mobile device, such as a smartphone, a tablet, or a smartwatch, that typically have built-in GPS and Bluetooth modules.

In some embodiments, the user device 106 may include a user interface 204 for setting up pre-approved locations and linking payment methods. The user interface 204 may provide an intuitive and user-friendly way for users to enter their pre-approved locations and payment method details. The user interface 204 may include various tools and features to assist the user in the setup process, such as a map for selecting pre-approved locations, a form for entering payment method details, and a list for viewing and managing the pre-approved locations and linked payment methods.

In some cases, the user interface 204 may include a visual configuration option that, upon activation by the user, modifies the display properties of the user interface elements to present a dark mode theme. This dark mode theme may comprise a majority of user interface elements rendered with a color luminance value that falls within the lower twenty percent of the standard RGB color space. The dark mode theme can reduce the light emitted by the display, minimizing eye strain in low ambient light conditions. The user interface may provide a toggle switch within the settings menu that is configured to switch between the dark mode theme and a standard light mode theme. The dark mode theme is specifically designed to maintain readability of text and interactive elements by adjusting the contrast ratio to meet or exceed the level recommended by the Web Content Accessibility Guidelines (WCAG) for visual presentation.

In some aspects, the PSA 102 may deploy Bluetooth beacons 214 for accurate indoor location verification. These beacons 214 can be strategically placed in specific indoor locations, such as stores or offices, to enhance the accuracy of location verification. The user device 106, equipped with Bluetooth capabilities, can detect the signals from these beacons when it is within the range of the beacon. By identifying the signals from these beacons, the PSA 102 can determine whether the user device is within a specific indoor location. In some cases, the PSA 102 may ensure compatibility with various Bluetooth beacon standards for seamless operation.

In some aspects, the PSA 102 may implement various security measures to protect user data and enhance the security of transactions. One such measure may involve encrypting all location and transaction data. The encryption process may convert the data into a format that can be read and understood by authorized parties, but not by unauthorized parties. The encryption process may use various encryption algorithms, such as symmetric encryption, asymmetric encryption, or a combination of both, to provide a high level of data security. In some cases, the encryption process may be applied to all location data, including GPS coordinates, Bluetooth beacon identifiers, Wi-Fi access point identifiers, and cellular tower identifiers. This can ensure that the user's location information is protected from unauthorized access or tampering. In other cases, the encryption process may be applied to all transaction data, including payment method details, transaction amounts, and transaction timestamps. This can ensure that the user's transaction information is protected from unauthorized access or tampering.

In some embodiments, the PSA 102 may support biometric authentication for app access and override authorization. Biometric authentication can provide a high level of security, as it relies on the user's physical or behavioral characteristics, which are difficult to replicate or steal. In some cases, the biometric authentication may include fingerprint recognition. The user device 106 may include a fingerprint sensor, which can capture an image of the user's fingerprint and compare it with the fingerprint data stored in the user's profile. If the captured fingerprint matches the stored fingerprint, the user may be granted access to the app or allowed to override the location restriction for a payment. In other cases, the biometric authentication may include facial recognition. The user device may include a camera, which can capture an image of the user's face and compare it with the facial data stored in the user's profile. If the captured facial features match the stored facial features, the user may be granted access to the app or allowed to override the location restriction for a payment.

In some aspects, the PSA 102 may periodically prompt the user to re-verify their pre-approved locations. This can ensure that the pre-approved locations are up-to-date and accurate, reducing the risk of unauthorized transactions from outdated or irrelevant locations. The re-verification process may involve the user confirming their current locations, adding new locations, or removing outdated locations. The PSA may initiate this re-verification process at predetermined intervals, ensuring a regular update of the pre-approved locations.

In some embodiments, the PSA 102 may be designed to integrate with major payment gateways and mobile wallet providers. This integration can provide a seamless and secure payment experience, allowing the PSA 102 to authorize payments without disrupting the user's payment flow. The integration may be facilitated using APIs and SDKs provided by the payment gateways and mobile wallet providers. These APIs and SDKs can provide a set of tools, protocols, and routines for building software and applications, allowing the PSA 102 to communicate and interact with the payment gateways and mobile wallets in a secure and standardized manner.

In some aspects, the PSA 102 may be designed to integrate with other types of systems or platforms beyond payment gateways and mobile wallets. For instance, the PSA 102 may integrate with e-commerce platforms to provide location-based payment security for online shopping. In this scenario, the PSA 102 may verify the user's location during the checkout process, authorizing the payment if the user's location matches a pre-approved location. This can enhance the security of online shopping, reducing the risk of fraudulent transactions.

In other cases, the PSA 102 may integrate with banking apps or financial management apps to provide a comprehensive financial security solution. In these cases, the PSA 102 may verify the user's location during various financial transactions, such as transfers, withdrawals, or deposits, authorizing the transaction if the user's location matches a pre-approved location. This can provide a robust and holistic approach to financial security, protecting users from a wide range of fraudulent activities.

In yet other cases, the PSA 102 may be designed to integrate with other systems or platforms that require secure access control. For example, the PSA 102 could be integrated with building access control systems to ensure that access is granted to authorized individuals when they are physically present at the location. The pre-approved locations feature of the PSA 102 could be used to specify the locations, such as office buildings or residential complexes, where access is permitted. The real-time location matching and user notifications features could be used to monitor and control access in real-time, alerting security personnel of any unauthorized access attempts.

In some embodiments, the PSA 102 could be applied in the automotive industry as a security measure to prevent vehicle theft. The location verification feature of the PSA 102 could be used to ensure that a vehicle can be started or operated when the owner's device is physically present in the vehicle. The pre-approved locations feature could be used to specify the locations, such as home or office, where the vehicle can be started or operated. The real-time location matching and user notifications features could be used to monitor and control vehicle operation in real-time, alerting the owner of any unauthorized attempts to start or operate the vehicle.

In other embodiments, the PSA 102 could be used in the digital services industry as a security measure to prevent unauthorized access to digital services such as streaming platforms, cloud storage, and online gaming platforms. The location verification feature of the PSA 102 could be used to ensure that access to these services is granted when the user's device is physically present at a pre-approved location. The real-time location matching and user notifications features could be used to monitor and control access in real-time, alerting the user of any unauthorized access attempts.

In yet other embodiments, the PSA 102 could be used in the government sector to secure electronic voting in elections. The location verification feature of the PSA 102 could be used to ensure that a vote is cast when the voter's device is physically present at a pre-approved location, such as a polling station or home. The real-time location matching and user notifications features could be used to monitor and control voting in real-time, alerting the voter of any unauthorized voting attempts.

In some aspects, the PSA 102 could be used in the healthcare industry to secure access to electronic medical records. The location verification feature of the PSA could be used to ensure that access to medical records is granted when the healthcare provider's device is physically present at a pre-approved location, such as a hospital or clinic. The real-time location matching and user notifications features could be used to monitor and control access in real-time, alerting the healthcare provider of any unauthorized access attempts.

In the context of the Payment Security App (PSA), the hardware components play a foundational role in the system's operation. The user device, which may be a smartphone, tablet, or smartwatch, is equipped with a GPS module to receive signals from satellites for location determination. Additionally, the device contains a Bluetooth module to communicate with Bluetooth beacons, which are hardware components deployed in various locations to provide precise indoor positioning. These beacons emit signals that the user device can detect, enabling the system to verify the user's presence within a designated area. Furthermore, for biometric authentication, the user device may incorporate specialized sensors such as fingerprint scanners or cameras capable of facial recognition, adding a layer of security by tying the transaction authorization to the user's physical presence.

The software components of the PSA are integral to its functionality. The application running on the user device includes a user interface that allows users to manage their pre-approved locations and payment methods. This interface is designed to be intuitive, guiding users through the process of setting up and maintaining their account settings. The software also includes various modules responsible for location verification, payment authorization, and notification delivery. These modules work in concert to ensure that transactions are authorized based on the user's location and that any attempts to transact from unapproved locations are promptly reported to the user. The software is designed to be adaptable, with the ability to integrate with APIs and SDKs from payment gateways and mobile wallet providers, thereby facilitating a seamless and secure payment process.

On the cloud side, the PSA system may utilize cloud-based services for several purposes. Cloud storage can be employed to securely store user data, including pre-approved locations, payment method details, and transaction history. This data is encrypted to protect user privacy and prevent unauthorized access. Cloud computing resources are also used to process large volumes of location and transaction data, enabling real-time decision-making for payment authorization. Additionally, cloud services can provide the infrastructure for sending notifications to users via various channels, such as SMS or email, ensuring that users are informed of any payment attempts from unapproved locations regardless of their current device usage.

The PSA's cloud infrastructure is designed to be scalable, capable of handling a growing number of users and transactions without compromising performance. It employs robust security measures, such as firewalls, intrusion detection systems, and regular security audits, to safeguard against potential threats. The cloud services are also configured to comply with relevant data protection regulations, ensuring that user data is handled in accordance with legal requirements.

To facilitate the integration of the PSA with external systems, the cloud components may also include a set of web services that expose APIs for communication with payment gateways, mobile wallet providers, and other financial systems. These web services act as a bridge between the PSA and the external systems, translating requests and responses so that they can be understood by both parties. This allows for the extension of the PSA's capabilities, enabling it to function within a broader ecosystem of financial services and platforms.

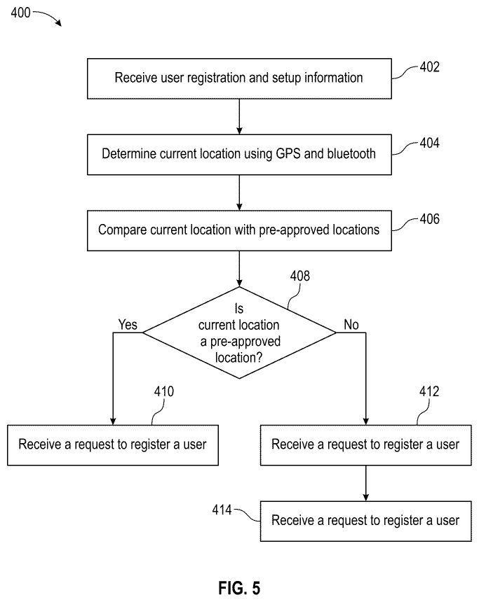

Now referring to FIG. 5, a method 400 of preventing fraudulent electronic payments is explained, in accordance with one embodiment of the present invention. The order in which method 400 is described should not be construed as a limitation, and any number of the described method blocks can be combined in any order to implement method 400 or alternate methods. Additionally, individual blocks may be deleted from method 400 without departing from the spirit and scope of the invention described herein. Furthermore, method 400 can be implemented in any suitable hardware, software, firmware, or combination thereof. However, for ease of explanation, in the embodiments described below, method 400 may be implemented using the above-described PSA 102.

The method 400 starts at step 402. At step 402, the PSA 102 receives user registration and setup information. The information may include pre-approved locations where the user frequently makes payments and the payment methods linked to the user's account. The pre-approved locations may be stored as GPS coordinates and Bluetooth beacon identifiers, providing a comprehensive dataset for location verification, as shown at step. At step 404, when the user 110 wishes to make payment, the PSA 102 determines the location of the user device 106 using the location details determined by the GPS module 210 and/or the second transceiver/Bluetooth 212. At step 406, the PSA 102 compares the current location of the user device 106 with the pre-approved locations. At step 408, the PSA 102 checks whether the current location matches with the pre-approved locations. If the location matches, then the method 400 moves to step 410. At step 410, the PSA 102 authorizes the payment.

If the current location does not match with the pre-approved locations at step 408, then the method 400 moves to step 412. At step 412, the PSA 102 detects the payment attempt from an unapproved location. Subsequently, the PSA 102 sends a notification to the user 110 on the user device 106 of the payment attempt, as shown at step 414.

In some aspects, the PSA 102 may implement machine learning algorithms to enhance its fraud detection capabilities by adapting to a user's payment patterns and location history. This adaptive approach allows the system to create a more personalized and accurate fraud detection model for each user.

The machine learning module of the PSA 102 may collect and analyze various data points related to the user's payment behavior and location patterns. These data points may include, but are not limited to, the frequency of transactions, typical transaction amounts, common merchants, time of day for transactions, and the user's movement patterns between pre-approved locations.

In some cases, the machine learning algorithm may employ supervised learning techniques. The system may be initially trained on a dataset of known fraudulent and legitimate transactions, learning to distinguish between the two based on various features. As the user interacts with the PSA 102 over time, the algorithm may continue to learn and refine its model based on the user's specific behavior patterns.

The PSA 102 may utilize unsupervised learning techniques to detect anomalies in the user's behavior. This approach may allow the system to identify unusual patterns that deviate from the user's normal behavior, even if these patterns don't match known fraudulent activities. For example, if a user typically makes small transactions at local stores but suddenly makes a large purchase from an unfamiliar merchant in a different city, the system may flag this as potentially suspicious.

In some implementations, the machine learning module may incorporate reinforcement learning techniques. The system may learn from the outcomes of its fraud detection decisions, adjusting its model based on whether its alerts were accurate or false positives. This approach may allow the PSA 102 to continuously improve its fraud detection accuracy over time.

The machine learning algorithm may also analyze the user's location history to create a dynamic model of the user's typical movement patterns. This model may take into account factors such as the user's daily commute, frequent travel destinations, and seasonal variations in location. By understanding these patterns, the PSA 102 may be able to more accurately distinguish between legitimate location changes and potentially fraudulent activities.

In some aspects, the machine learning module may employ ensemble methods, combining multiple algorithms to improve overall fraud detection performance. This approach may allow the system to leverage the strengths of different algorithms and mitigate their individual weaknesses.

The PSA 102 may use the insights generated by the machine learning module to dynamically adjust its security settings. For example, if the system detects that a user frequently travels to a particular city for business, it may automatically add frequently visited locations in that city to the list of pre-approved locations. Conversely, if the system detects that a previously frequent location hasn't been visited in a long time, it may suggest removing it from the pre-approved list.

In some implementations, the machine learning module may analyze patterns across multiple users to identify broader fraud trends. This analysis may be performed on anonymized data to protect user privacy. The insights gained from this cross-user analysis may be used to update and improve the overall fraud detection capabilities of the PSA 102.

The machine learning module may also adapt to changes in the user's behavior over time. For instance, if a user's spending patterns change due to a new job or lifestyle change, the system may recognize this shift and adjust its fraud detection parameters accordingly. This adaptive approach may help reduce false positives and ensure that the PSA 102 remains effective as the user's circumstances evolve.

In some cases, the machine learning algorithm may incorporate natural language processing techniques to analyze transaction descriptions and merchant names. This analysis may help the system better understand the context of transactions and identify potentially suspicious activities based on the nature of the transaction.

The PSA 102 may provide users with insights generated by the machine learning module, such as visualizations of their spending patterns or location history. This transparency may help users understand how the system is protecting them and may also allow users to provide feedback, further improving the accuracy of the fraud detection model.

In some aspects, the PSA 102 may utilize a “location fingerprint” feature to enhance the accuracy and security of its location-based payment authorization system. A location fingerprint may be a unique identifier created by combining multiple data points related to a specific location, providing a more comprehensive and reliable method of location verification than traditional GPS coordinates alone.

The location fingerprint may be generated using a combination of various location-related data sources, which may include GPS coordinates, Bluetooth beacon identifiers, Wi-Fi network information, cellular tower data, and other ambient signals. By incorporating multiple data points, the location fingerprint may provide a more robust and tamper-resistant method of verifying a user's location.

In some cases, the PSA 102 may create a location fingerprint for each pre-approved location during the initial setup process. When a user adds a new pre-approved location, the system may collect and store various location-related data points to create a unique fingerprint for that specific location. This fingerprint may be periodically updated to account for changes in the environment, such as new Wi-Fi networks or Bluetooth beacons.

When a user attempts to make a payment, the PSA 102 may generate a real-time location fingerprint using the current data from the user device 106. This real-time fingerprint may then be compared to the stored fingerprints of pre-approved locations. If a match is found within a certain threshold of similarity, the payment may be authorized.

The use of location fingerprints may provide several advantages over traditional location verification methods. For instance, it may be more difficult for malicious actors to spoof a location, as they would need to replicate multiple aspects of the location's signature. Additionally, location fingerprints may provide more accurate results in areas where GPS signals are weak or unreliable, such as indoor environments or urban areas with tall buildings.

In some implementations, the PSA 102 may use machine learning algorithms to improve the accuracy of location fingerprint matching over time. The system may learn to identify which components of the fingerprint are most reliable for a given location and adjust the matching criteria accordingly. This adaptive approach may help reduce false positives and negatives in location verification.

The location fingerprint feature may also be used to detect potential fraudulent activities. For example, if a user's device reports a location fingerprint that partially matches a pre-approved location but contains unexpected elements, the PSA 102 may flag this as a potential security risk and require additional verification before authorizing the payment.

In some cases, the PSA 102 may allow users to customize the sensitivity of the location fingerprint matching for different pre-approved locations. For instance, a user may choose to set a stricter matching threshold for high-value transactions or for locations they visit less frequently.

The location fingerprint technology may also be leveraged to provide additional services within the PSA 102. For example, it may be used to offer location-based rewards or discounts, or to provide users with insights about their spending patterns at different locations.

By incorporating location fingerprints into its security framework, the PSA 102 may provide a more nuanced and reliable approach to location-based payment authorization, enhancing both the security and user experience of the system.

In some aspects, the PSA 102 may offer a comprehensive set of customizable security settings to enhance user control and system flexibility. These settings may allow users to fine-tune the security parameters according to their individual needs and preferences.

The customizable security settings may include location accuracy thresholds. Users may be able to adjust the precision required for location matching, setting stricter or more lenient parameters depending on their security concerns. For instance, a user may set a tighter radius for location matching in urban areas and a wider radius in rural areas where GPS signals may be less precise.

In some cases, the PSA 102 may allow users to set different payment amount limits for each pre-approved location. For example, a user may set a higher transaction limit for their home address compared to a frequently visited coffee shop. This granular control may help users manage their spending and add an extra layer of security for high-value transactions.

The customizable security settings may also include time-based restrictions for authorizing payments. Users may be able to set specific time windows during which transactions are allowed at certain locations. For instance, a user may only allow transactions at their workplace during business hours.

In some implementations, the PSA 102 may offer customizable alert settings. Users may be able to choose the types of notifications they receive, the channels through which they receive them (e.g., push notifications, SMS, email), and the frequency of these alerts. They may also be able to set different alert thresholds for different types of transactions or locations.

In some aspects, the PSA 102 may automatically adjust the frequency of prompting the user to re-verify their pre-approved locations based on the user's transaction history and risk profile. This adaptive approach may help balance security needs with user convenience. For users with consistent transaction patterns and low-risk profiles, the system may reduce the frequency of re-verification prompts, minimizing potential disruptions to their user experience. Conversely, for users with more variable transaction patterns or higher-risk profiles, the PSA 102 may increase the frequency of re-verification prompts to maintain a higher level of security. The system may also consider factors such as the time elapsed since the last re-verification, the number of transactions made at each pre-approved location, and any detected anomalies in the user's behavior. This dynamic adjustment of re-verification frequency may help ensure that the PSA 102 maintains an optimal balance between security and usability for each individual user.

The PSA 102 may allow users to customize the secondary authentication methods required for transactions from new or infrequently visited locations. Users may be able to choose between various options such as biometric verification, PIN entry, or answering security questions, and may be able to set different authentication requirements for different transaction types or amounts.

In some aspects, the customizable security settings may include options for managing the machine learning features of the PSA 102. Users may be able to adjust the sensitivity of the anomaly detection algorithms, choose which factors are considered in fraud detection, or opt in or out of certain types of data collection for machine learning purposes.

The PSA 102 may offer customizable settings for the location fingerprint feature. Users may be able to adjust the weight given to different components of the location fingerprint (e.g., GPS, Wi-Fi, Bluetooth) or set different matching thresholds for different types of locations.

In some cases, the customizable security settings may include options for managing pre-approved locations. Users may be able to set expiration dates for temporary locations, automatically remove locations that haven't been visited in a certain period, or set different security levels for different categories of locations (e.g., home, work, frequently visited stores).

The PSA 102 may allow users to customize their travel mode settings. Users may be able to pre-approve locations for upcoming trips, set temporary changes to their security settings for travel periods, or enable automatic travel mode detection based on their location patterns.

In some implementations, the customizable security settings may include options for managing linked payment methods. Users may be able to set different security levels or usage restrictions for different payment methods, or link certain payment methods to specific locations or transaction types.

The PSA 102 may offer customizable privacy settings, allowing users to control how their data is used and shared within the system. This may include options to anonymize certain types of data, control data retention periods, or manage permissions for third-party integrations.

In some aspects, the customizable security settings may include options for managing the user interface of the PSA 102. Users may be able to choose between different layout options, customize the information displayed on their dashboard, or set up shortcuts for frequently used features.

The PSA 102 may allow users to set up and customize security questions or personal identification codes that can be used as an additional layer of verification for high-risk transactions or account changes.

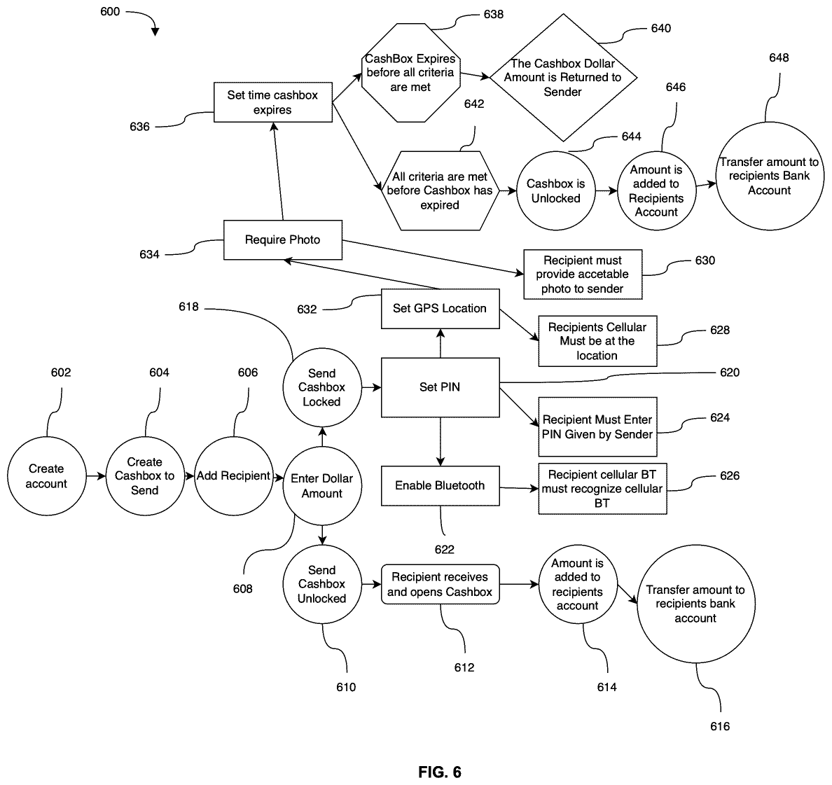

FIG. 6 illustrates a comprehensive flowchart for a secure payment process 600 utilizing a CashBox concept. A CashBox, in this context, represents a virtual container for transferring funds securely between users. The process 600 begins with step 602, where a user creates an account within the Payment Security Application (PSA). Following account creation, in step 604, the user initiates the process by creating a CashBox to send funds. The user then adds a recipient in step 606 and enters the dollar amount to be transferred in step 608.

At this point, the process 600 diverges into two main paths: sending a CashBox unlocked (step 610) or locked (step 618). The unlocked option provides a simpler, more direct transfer method, while the locked option incorporates multiple security measures for enhanced protection.

For the unlocked CashBox option, the process proceeds as follows: 1. In step 612, the recipient receives and opens the CashBox. 2. The amount is then added to the recipient's account in step 614. 3. Finally, in step 616, the amount is transferred to the recipient's bank account.

The locked CashBox option, starting from step 618, involves a series of security measures: 1. In step 620, the sender sets a PIN for the CashBox. 2. Step 622 involves enabling Bluetooth on the sender's device. 3. The sender sets a GPS location requirement in step 632. 4. A photo requirement is established in step 634. 5. In step 636, the sender sets a time for the CashBox to expire.

For the recipient to unlock a locked CashBox, several criteria must be met: 1. The recipient's cellular Bluetooth must recognize the sender's cellular Bluetooth (step 626). 2. The recipient must enter the PIN provided by the sender (step 624). 3. The recipient's cellular device must be at the specified GPS location (step 628). 4. The recipient must provide an acceptable photo to the sender (step 630).

The process then reaches a decision point at step 638, where it checks if the CashBox expires before all criteria are met. If the CashBox expires, the process moves to step 640, where the CashBox dollar amount is returned to the sender. If all criteria are met before expiration, the process continues to step 642.

When all criteria are satisfied, the CashBox is unlocked in step 644. Subsequently, in step 646, the amount is added to the recipient's account. Finally, in step 648, the amount is transferred to the recipient's bank account.

This detailed process leverages various security features of the PSA, such as GPS location verification, Bluetooth proximity detection, and biometric authentication (photo requirement). It also incorporates time-based security through the expiration feature. The CashBox concept allows for flexible, secure transfers with options for both high-security transactions and simpler, immediate transfers between trusted parties.

In some implementations, the PSA 102 may offer enhanced verification options for the CashBox feature, providing users with additional layers of security for their transactions. These options may include video and photo requirements, as well as video call verification.

The PSA 102 may allow users to set a video requirement as a security measure for unlocking a CashBox. In this case, the sender may specify that the recipient must record and submit a short video as part of the verification process. The video requirement may include specific instructions, such as the recipient stating a predetermined phrase or showing a particular object in the video. This feature may help verify the recipient's identity and ensure that they are physically present at the specified location.

In some aspects, the PSA 102 may incorporate advanced video analysis techniques to enhance the security of the video verification process. These techniques may include facial recognition, voice recognition, or even gesture analysis to confirm the recipient's identity and compliance with the sender's instructions.

The photo requirement option may be expanded to allow for more specific and customizable photo verifications. Users may be able to set requirements for the photo, such as including a specific background landmark, displaying a particular item, or capturing a time-stamped image. The PSA 102 may utilize image recognition algorithms to automatically verify that the submitted photo meets the specified criteria.

In some cases, the PSA 102 may offer a real-time video call option as an additional security measure for high-value transactions or transfers to new recipients. This feature may allow the sender and recipient to engage in a live video call through the PSA 102 interface. During the call, the sender may visually confirm the recipient's identity and location, adding an extra layer of verification to the transaction process.

The video call feature may include built-in security measures to prevent spoofing or pre-recorded video playback. These measures may include random prompts for the recipient to perform specific actions or answer dynamically generated questions during the call.

Users may have the option to combine multiple verification methods for a single CashBox transfer. For instance, a user may require both a photo and a video submission, or a combination of GPS location verification and a video call. This multi-factor approach may provide an even higher level of security for sensitive transactions.

The PSA 102 may allow users to customize the verification requirements based on various factors such as transaction amount, recipient relationship, or location type. For example, a user may set stricter verification requirements for high-value transfers or transactions with new recipients, while allowing simpler verification processes for frequent, low-value transfers to trusted contacts.

In some implementations, the PSA 102 may use machine learning algorithms to analyze patterns in user behavior and transaction history to suggest appropriate verification methods. The system may learn from successful and failed verification attempts to continuously improve its recommendations and security measures.

The PSA 102 may also provide options for storing and managing verification media securely. Users may be able to review past verification photos and videos within the app, with the data being encrypted and protected to ensure user privacy and compliance with data protection regulations.

In some embodiments, the PSA 102 may offer an advanced video verification feature for approving payments. This feature may allow the sender to preview a video or require the recipient to provide a specific type of video or facial image at a certain location before authorizing the transfer.

The video verification process may be initiated at the discretion of the sender and agreed upon by the recipient. The sender may specify the type of video content required, which could range from a simple facial recognition check to a more complex scenario where the recipient needs to perform specific actions or show particular objects in the video.

In some cases, the sender may require the recipient to record a video at a specific location. This location-based video verification may add an extra layer of security by ensuring that the recipient is physically present at an agreed-upon place. The PSA 102 may utilize its location verification capabilities in conjunction with the video feature to confirm the recipient's whereabouts.

The video verification feature may also support real-time streaming options. In this scenario, the sender could request a live video call with the recipient, allowing for direct visual confirmation of the recipient's identity and location. During the call, the sender may ask the recipient to perform certain actions or show specific items to further verify their identity.

To enhance privacy and security, the PSA 102 may implement end-to-end encryption for all video transmissions. This encryption may ensure that only the intended parties can view the video content, protecting sensitive information from potential interception.

The PSA 102 may also incorporate advanced video analysis techniques to assist in the verification process. These may include facial recognition algorithms to match the recipient's face with stored profile images, or gesture recognition to confirm that the recipient is following specific instructions provided by the sender.

In some implementations, the PSA 102 may offer a feature where the sender can pre-record a set of instructions or questions for the recipient to respond to in their verification video. This asynchronous approach may provide flexibility in cases where real-time interaction is not feasible due to time zone differences or scheduling conflicts.

The video verification feature may be customizable, allowing senders to set different requirements based on factors such as transaction amount, recipient relationship, or frequency of interactions. For instance, a sender may require more stringent video verification for high-value transfers or transactions with new recipients, while opting for simpler verification methods for frequent, low-value transfers to trusted contacts.

To streamline the process, the PSA 102 may provide templates or guidelines for both senders and recipients on how to create and submit effective verification videos. These guidelines may include tips on lighting, camera angles, and clear audio to ensure that the verification process goes smoothly.

In cases where video verification is used, the PSA 102 may securely store the verification videos for a limited time period, as specified in the app's data retention policies. This storage may allow for later review if any disputes arise, while also ensuring that sensitive data is not kept indefinitely.

The PSA 102 may also offer an option for users to set up trusted recipient lists, where video verification requirements can be pre-configured for different groups of contacts. This feature may help balance security needs with user convenience for frequent transactions.

The process 600 demonstrates how the PSA integrates multiple layers of security, including location-based verification (GPS and Bluetooth), time-based controls, and user-defined security measures (PIN and photo requirements). This comprehensive approach aligns with the PSA's core functionality of enhancing payment security through advanced location-based and multi-factor authentication methods.

In some cases, the customizable security settings may include options for managing device-specific security features. Users may be able to enable or disable certain features based on the capabilities of their device, such as using device-level encryption, leveraging secure enclaves for storing sensitive data, or utilizing device-specific biometric features.

As used herein, the term “user device” may refer to any portable electronic device that a user may carry or wear, which is equipped with the capability to communicate with other devices or systems. This includes, but is not limited to, smartphones, tablets, and smartwatches. These devices typically have built-in features such as GPS modules for receiving location signals, Bluetooth modules for short-range wireless communication, and may include biometric sensors for user authentication.

The term “GPS module” refers to the hardware within a user device that is capable of receiving signals from satellites in the Global Positioning System network. The GPS module uses these signals to determine the geographical location of the user device with varying degrees of accuracy, depending on factors such as signal strength and satellite visibility.

The term “Bluetooth module” refers to the hardware within a user device that enables wireless communication over short distances using Bluetooth technology. This module can detect signals from Bluetooth beacons, which are external devices that emit Bluetooth signals for the purpose of indoor location verification and other proximity-based services.

The term “Bluetooth beacons” refers to small hardware devices that emit a Bluetooth signal that can be detected by nearby user devices with Bluetooth capabilities. These beacons are used for indoor positioning and can provide precise location data within buildings or other structures where GPS signals may be limited.

The term “biometric authentication” encompasses methods of verifying a user's identity based on their physical or behavioral characteristics. This may include fingerprint recognition, facial recognition, voice recognition, iris scanning, and other biometric modalities. Biometric authentication provides a high level of security by ensuring that access to a device or application is granted based on uniquely identifiable traits of the user.

The term “cloud storage” refers to the model of storing data on remote servers that are accessed from the internet, or “the cloud.” This data is maintained, managed, and backed up remotely, and made available to users over a network, typically allowing for user access from various locations and devices.

The term “cloud computing resources” refers to the processing power, storage, and networking capabilities provided by cloud service providers. These resources are used to handle large volumes of data and complex computations, and can be scaled up or down according to the demands of the applications they support.

The term “APIs” or “Application Programming Interfaces” are sets of protocols, tools, and definitions for building application software and enabling communication between different software applications. APIs allow different systems to interact with each other without knowing the internal workings of each other's software.

The term “SDKs” or “Software Development Kits” are collections of software tools and programs used by developers to create applications for specific platforms. SDKs typically include libraries, documentation, code samples, processes, and guides that facilitate the development of applications.

The term “web services” refers to a standardized way of integrating web-based applications using open standards over an internet protocol backbone. Web services allow different applications from various sources to communicate with each other without time-consuming custom coding, and are used for machine-to-machine interaction over a network.

The Payment Security App (PSA) presents a multitude of advantages over prior art, primarily in its multifaceted approach to security and its seamless integration capabilities. The PSA's utilization of both GPS and Bluetooth technologies for location verification offers a dual-layered security mechanism that is more robust than systems relying on a single technology. This combination allows for precise location determination, even in challenging environments where one technology alone may not be reliable, such as indoors where GPS signals are weak. By leveraging Bluetooth beacons in conjunction with GPS, the PSA ensures accurate location verification, enhancing the security of transactions and access control.

Moreover, the PSA's real-time location matching capability represents a substantial improvement over prior systems that may have relied on periodic or delayed verification methods. This feature allows for immediate detection and response to unauthorized access attempts, providing a proactive security measure that can prevent fraudulent activities before they occur. The integration of user notifications further strengthens this advantage by promptly alerting users to any suspicious activity, enabling them to take swift action to secure their accounts and assets.

The adaptability of the PSA's software components is another notable advancement. The user interface is designed with the end-user in mind, offering an intuitive and accessible experience for managing security settings and payment methods. The modular nature of the software allows for easy updates and the addition of new features, ensuring that the PSA can evolve with emerging security threats and user requirements. The ability to integrate with APIs and SDKs from various payment gateways and mobile wallet providers ensures that the PSA can operate within the existing financial ecosystem without necessitating extensive modifications to current systems.

The cloud-based infrastructure of the PSA provides scalability and flexibility that surpasses many traditional security systems. Cloud storage and computing resources enable the PSA to handle vast amounts of data and complex processing tasks, facilitating real-time decision-making and transaction authorization. The cloud services are equipped with advanced security measures and comply with data protection regulations, offering users peace of mind that their sensitive information is safeguarded.

Furthermore, the PSA's cloud components include web services that enable seamless integration with external systems, extending the application's functionality beyond payment security. This interoperability allows the PSA to be utilized in various sectors, including healthcare, government, automotive, and digital services, demonstrating its versatility and wide-ranging applicability.

In summary, the PSA offers a comprehensive and advanced solution for securing electronic payments and access control. Its use of dual-location verification technologies, real-time monitoring, user-centric design, and cloud-based scalability provides a superior alternative to prior art, addressing the limitations of existing systems and setting a new standard for security in the digital age.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. Also, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purposes only and should not be construed in a limited sense. A person skilled in the art will appreciate alternate components that may be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants included in the scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Aspects of the present disclosure can be understood by embodiments outlined in the following clauses.
Clause 1. A payment security system, comprising: a user device (106) equipped with GPS (210) and Bluetooth (212) capabilities; a location verification module (156) configured to determine a current location of the user device (106) using at least one of GPS and Bluetooth signals; a payment authorization module (158) configured to authorize payments if the current location matches a pre-approved location; and a notification module (162) configured to alert a user (110) of payment attempts from unapproved locations.
Clause 2. The payment security system of Clause 1, wherein the user device (106) is a mobile device selected from the group consisting of a smartphone, a tablet, and a smartwatch.
Clause 3. The payment security system of Clause 1, wherein the location verification module (156) further comprises a Wi-Fi triangulation system for determining the current location of the user device (106).
Clause 4. The payment security system of Clause 1, wherein the payment authorization module (158) further comprises a secondary authentication method for authorizing payments from a new location, the secondary authentication method selected from the group consisting of biometric verification and a personal identification number (PIN).
Clause 5. The payment security system of Clause 4, wherein the biometric verification includes at least one of fingerprint recognition and facial recognition.
Clause 6. The payment security system of Clause 1, wherein the notification module (162) sends alerts to the user (110) via at least one method selected from the group consisting of in-app notifications, SMS, email, and automated phone calls.
Clause 7. The payment security system of Clause 1, further comprising: a user interface (204) on the user device (106) for setting up pre-approved locations and linking payment methods; wherein the location verification module (156) is configured to use a combination of GPS, Bluetooth, and Wi-Fi signals to create a location fingerprint for each pre-approved location; wherein the payment authorization module (158) is configured to implement an algorithm that adapts to the user's payment patterns and location history to detect anomalies and prevent fraudulent transactions; wherein the notification module (162) is configured to send alerts to the user (110) via multiple channels simultaneously; a machine learning module configured to analyze user behavior patterns and continuously improve fraud detection capabilities; and a secure backup and recovery system for user data and preferences.
Clause 8. A method for securing electronic payments, comprising: receiving (402) user registration and setup information, including pre-approved locations and linked payment methods; determining (404) a current location of a user device (106) using at least one of GPS and Bluetooth signals; comparing (406) the current location with the pre-approved locations; authorizing (410) a payment if the current location matches a pre-approved location; and sending (414) a notification to a user (110) if a payment attempt from an unapproved location is detected.
Clause 9. The method of Clause 8, wherein the user registration and setup information further includes a secondary authentication method for authorizing payments from a new location, the secondary authentication method selected from the group consisting of biometric verification and a personal identification number (PIN).
Clause 10. The method of Clause 9, wherein the biometric verification includes at least one of fingerprint recognition and facial recognition.
Clause 11. The method of Clause 8, wherein determining (404) the current location of the user device (106) further comprises using a Wi-Fi triangulation system.
Clause 12. The method of Clause 8, wherein sending (414) the notification to the user (110) comprises sending the notification via at least one method selected from the group consisting of in-app notifications, SMS, email, and automated phone calls.
Clause 13. The method of Clause 8, further comprising periodically prompting the user (110) to re-verify their pre-approved locations.
Clause 14. The method of Clause 8, further comprising: receiving a secondary authentication method for authorizing payments from a new location, the secondary authentication method selected from the group consisting of biometric verification and a personal identification number (PIN); wherein the biometric verification includes at least one of fingerprint recognition and facial recognition; wherein determining (404) the current location of the user device (106) further comprises using a Wi-Fi triangulation system; wherein sending (414) the notification to the user (110) comprises sending the notification via at least one method selected from the group consisting of in-app notifications, SMS, email, and automated phone calls; periodically prompting the user (110) to re-verify their pre-approved locations; implementing a machine learning algorithm that adapts to the user's payment patterns and location history to detect anomalies and prevent fraudulent transactions; creating a location fingerprint for each pre-approved location using a combination of GPS. Bluetooth, and Wi-Fi signals to enhance location verification accuracy; providing a customizable security settings menu allowing the user (110) to set location accuracy thresholds, payment amount limits for each pre-approved location, and time-based restrictions for authorizing payments; and automatically adjusting the frequency of prompting the user (110) to re-verify their pre-approved locations based on the user's transaction history and risk profile.
Clause 15. A non-transitory computer-readable medium storing instructions that, when executed by a processor (150), cause a device to: receive user registration and setup information, including pre-approved locations and linked payment methods; determine a current location of a user device (106) using at least one of GPS and Bluetooth signals; compare the current location with the pre-approved locations; authorize a payment if the current location matches a pre-approved location; and send a notification to a user (110) if a payment attempt from an unapproved location is detected.
Clause 16. The non-transitory computer-readable medium of Clause 15, wherein the instructions further cause the device to encrypt all location and transaction data to protect user privacy.
Clause 17. The non-transitory computer-readable medium of Clause 15, wherein the instructions further cause the device to support biometric authentication for app access and override authorization, wherein the biometric authentication includes at least one of fingerprint recognition and facial recognition.
Clause 18. The non-transitory computer-readable medium of Clause 15, wherein the instructions further cause the device to periodically prompt the user (110) to re-verify their pre-approved locations.
Clause 19. The non-transitory computer-readable medium of Clause 15, wherein the instructions further cause the device to integrate with major payment gateways and mobile wallet providers using APIs and SDKs.
Clause 20. The non-transitory computer-readable medium of Clause 15, wherein the instructions further cause the device to: encrypt all location and transaction data to protect user privacy; support biometric authentication for app access and override authorization, wherein the biometric authentication includes at least one of fingerprint recognition and facial recognition; periodically prompt the user (110) to re-verify their pre-approved locations; integrate with major payment gateways and mobile wallet providers using APIs and SDKs; implement a machine learning algorithm to analyze user behavior patterns and detect potential fraudulent activities; provide a multi-factor authentication option for high-value transactions; automatically adjust security settings based on the user's risk profile and transaction history; offer a virtual payment card feature for enhanced security in online transactions; enable geofencing capabilities to create custom-sized safe zones around pre-approved locations; support offline transaction verification using locally stored encrypted data; implement real-time transaction monitoring with instant push notifications for suspicious activities; provide a secure backup and recovery system for user data and preferences; offer a travel mode feature that temporarily adjusts location-based security settings; integrate with third-party identity verification services for enhanced user authentication; and support dynamic transaction limits based on location, time, and user behavior patterns.

### REFERENCE NUMERALS

100 system environment
102 server
104 database
106 user device
108 application
110 user
112 network
114 financial institution
116 merchant
118 payment device
120 payment processor
150 processor
152 memory
154 user interface
156 location verification module
158 payment authorization module
160 transceiver
162 notification module
200 second processor
202 second memory
204 user interface
206 display
208 biometric sensor
210 GPS module
212 second transceiver
214 Bluetooth beacons
300 method for registering a user in a payment security system
302 step of receiving a request to register a user
304 step of receiving preferred locations for initiating payments from the user device
306 step of receiving information corresponding to payments linked to the user device
308 step of storing the information in a database
400 method for securing electronic payments
402 step of receiving user registration and setup information, including pre-approved locations and linked payment methods
404 step of determining a current location of a user device using at least one of GPS and Bluetooth signals
406 step of comparing the current location with the pre-approved locations
408 step of determining if the current location is a pre-approved location
410 step of authorizing a payment if the current location matches a pre-approved location
412 step of detecting a payment attempt from an unapproved location
414 step of sending a notification to a user if a payment attempt from an unapproved location is detected
600 process for secure payment using a CashBox concept
602 step of creating a user account within a payment security application
604 step of creating a CashBox to send funds
606 step of adding a recipient to the CashBox
608 step of entering a dollar amount for the funds transfer
610 step of sending the CashBox as unlocked
612 step of receiving and opening the unlocked CashBox by the recipient
614 step of adding the amount to the recipient's account
616 step of transferring the amount to the recipient's bank account
618 step of sending the CashBox as locked
620 step of setting a PIN for the locked CashBox
622 step of enabling Bluetooth on the sender's device
624 step of requiring the recipient to enter the PIN provided by the sender
626 step of verifying that the recipient's cellular Bluetooth recognizes the sender's cellular Bluetooth
628 step of verifying that the recipient's cellular device is at the specified GPS location
630 step of requiring the recipient to provide an acceptable photo to the sender
632 step of setting a GPS location requirement
634 step of setting a photo requirement
636 step of setting a time for the CashBox to expire
638 step of determining if the CashBox expires before all criteria are met
640 step of returning the CashBox dollar amount to the sender if the CashBox expires
642 step of proceeding if all criteria are met before expiration
644 step of unlocking the CashBox
646 step of adding the amount to the recipient's account
648 step of transferring the amount to the recipient's bank account

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

I claim:

1. A payment security system, comprising:
a user device (106) equipped with GPS (210) and Bluetooth (212) capabilities;
a location verification module (156) configured to determine a current location of the user device (106) using at least one of GPS and Bluetooth signals;
a payment authorization module (158) configured to authorize payments if the current location matches a pre-approved location; and
a notification module (162) configured to alert a user (110) of payment attempts from unapproved locations.

2. The payment security system of claim 1, wherein the user device (106) is a mobile device selected from the group consisting of a smartphone, a tablet, and a smartwatch.

3. The payment security system of claim 1, wherein the location verification module (156) further comprises a Wi-Fi triangulation system for determining the current location of the user device (106).

4. The payment security system of claim 1, wherein the payment authorization module (158) further comprises a secondary authentication method for authorizing payments from a new location, the secondary authentication method selected from the group consisting of biometric verification and a personal identification number (PIN).

5. The payment security system of claim 4, wherein the biometric verification includes at least one of fingerprint recognition and facial recognition.

6. The payment security system of claim 1, wherein the notification module (162) sends alerts to the user (110) via at least one method selected from the group consisting of in-app notifications, SMS, email, and automated phone calls.

7. The payment security system of claim 1, further comprising:
a user interface (204) on the user device (106) for setting up pre-approved locations and linking payment methods;
wherein the location verification module (156) is configured to use a combination of GPS, Bluetooth, and Wi-Fi signals to create a location fingerprint for each pre-approved location;
wherein the payment authorization module (158) is configured to implement an algorithm that adapts to the user's payment patterns and location history to detect anomalies and prevent fraudulent transactions;
wherein the notification module (162) is configured to send alerts to the user (110) via multiple channels simultaneously;
a machine learning module configured to analyze user behavior patterns and continuously improve fraud detection capabilities; and
a secure backup and recovery system for user data and preferences.

8. A method for securing electronic payments, comprising:
receiving (402) user registration and setup information, including pre-approved locations and linked payment methods;
determining (404) a current location of a user device (106) using at least one of GPS and Bluetooth signals;
comparing (406) the current location with the pre-approved locations;
authorizing (410) a payment if the current location matches a pre-approved location; and
sending (414) a notification to a user (110) if a payment attempt from an unapproved location is detected.

9. The method of claim 8, wherein the user registration and setup information further includes a secondary authentication method for authorizing payments from a new location, the secondary authentication method selected from the group consisting of biometric verification and a personal identification number (PIN).

10. The method of claim 9, wherein the biometric verification includes at least one of fingerprint recognition and facial recognition.

11. The method of claim 8, wherein determining (404) the current location of the user device (106) further comprises using a Wi-Fi triangulation system.

12. The method of claim 8, wherein sending (414) the notification to the user (110) comprises sending the notification via at least one method selected from the group consisting of in-app notifications, SMS, email, and automated phone calls.

13. The method of claim 8, further comprising periodically prompting the user (110) to re-verify their pre-approved locations.

14. The method of claim 8, further comprising:
receiving a secondary authentication method for authorizing payments from a new location, the secondary authentication method selected from the group consisting of biometric verification and a personal identification number (PIN);
wherein the biometric verification includes at least one of fingerprint recognition and facial recognition;
wherein determining (404) the current location of the user device (106) further comprises using a Wi-Fi triangulation system;
wherein sending (414) the notification to the user (110) comprises sending the notification via at least one method selected from the group consisting of in-app notifications, SMS, email, and automated phone calls;
periodically prompting the user (110) to re-verify their pre-approved locations;
implementing a machine learning algorithm that adapts to the user's payment patterns and location history to detect anomalies and prevent fraudulent transactions;
creating a location fingerprint for each pre-approved location using a combination of GPS, Bluetooth, and Wi-Fi signals to enhance location verification accuracy;
providing a customizable security settings menu allowing the user (110) to set location accuracy thresholds, payment amount limits for each pre-approved location, and time-based restrictions for authorizing payments; and
automatically adjusting the frequency of prompting the user (110) to re-verify their pre-approved locations based on the user's transaction history and risk profile.

15. A non-transitory computer-readable medium storing instructions that, when executed by a processor (150), cause a device to:
receive user registration and setup information, including pre-approved locations and linked payment methods;
determine a current location of a user device (106) using at least one of GPS and Bluetooth signals;
compare the current location with the pre-approved locations;
authorize a payment if the current location matches a pre-approved location; and
send a notification to a user (110) if a payment attempt from an unapproved location is detected.

16. The non-transitory computer-readable medium of claim 15, wherein the instructions further cause the device to encrypt all location and transaction data to protect user privacy.

17. The non-transitory computer-readable medium of claim 15, wherein the instructions further cause the device to support biometric authentication for app access and override authorization, wherein the biometric authentication includes at least one of fingerprint recognition and facial recognition.

18. The non-transitory computer-readable medium of claim 15, wherein the instructions further cause the device to periodically prompt the user (110) to re-verify their pre-approved locations.

19. The non-transitory computer-readable medium of claim 15, wherein the instructions further cause the device to integrate with major payment gateways and mobile wallet providers using APIs and SDKs.

20. The non-transitory computer-readable medium of claim 15, wherein the instructions further cause the device to:
encrypt all location and transaction data to protect user privacy;
support biometric authentication for app access and override authorization, wherein the biometric authentication includes at least one of fingerprint recognition and facial recognition;
periodically prompt the user (110) to re-verify their pre-approved locations;
integrate with major payment gateways and mobile wallet providers using APIs and SDKs;
implement a machine learning algorithm to analyze user behavior patterns and detect potential fraudulent activities;
provide a multi-factor authentication option for high-value transactions;
automatically adjust security settings based on the user's risk profile and transaction history;
offer a virtual payment card feature for enhanced security in online transactions;
enable geofencing capabilities to create custom-sized safe zones around pre-approved locations;
support offline transaction verification using locally stored encrypted data;
implement real-time transaction monitoring with instant push notifications for suspicious activities;
provide a secure backup and recovery system for user data and preferences;
offer a travel mode feature that temporarily adjusts location-based security settings;
integrate with third-party identity verification services for enhanced user authentication; and
support dynamic transaction limits based on location, time, and user behavior patterns.
